(19) United States
(12) Patent Application Publication
(10) Pub. No.: US 2026/0012727 A1
(43) Pub. Date: Jan. 8, 2026

(54) SOUND COLLECTION SETTING METHOD AND SOUND COLLECTION DEVICE

(71) Applicant: Yamaha Corporation, Hamamatsu (JP)

(72) Inventor: Satoshi UKAI, Hamamatsu (JP)

(21) Appl. No.: 19/327,946

(22) Filed: Sep. 12, 2025

Related U.S. Application Data
(63) Continuation of application No. PCT/JP2024/008015, filed on Mar. 4, 2024.

(30) Foreign Application Priority Data
Mar. 15, 2023 (JP) 2023-040527

(51) Int. Cl. H04R 1/34; G06T 7/70; H04R 1/08; H04R 29/00

(52) U.S. Cl. CPC H04R 1/342; G06T 7/70; H04R 29/004; G06T 2207/30201; H04R 1/08

(57) ABSTRACT

A sound collection method for setting directionality of a microphone includes setting a threshold separation angle, and orienting the directionality of the microphone toward a range of a sound source position where a separation angle between a normal direction of a surface on which the microphone is installed and a direction from a position at which the microphone is installed to a sound source is equal to or less than the threshold separation angle.

### CROSS-REFERENCE TO RELATED APPLICATIONS

This application is a continuation application of International Application No. PCT/JP2024/008015, filed on Mar. 4, 2024, which claims priority to Japanese Patent Application No. 2023-040527 filed in Japan on Mar. 15, 2023. The entire disclosures of International Application No. PCT/JP2024/008015 and Japanese Patent Application No. 2023-040527 are hereby incorporated herein by reference.

### BACKGROUND

### Technical Field

One embodiment of this disclosure generally relates to a sound collection setting method and a sound collection device.

### Background Information

U.S. Pat. No. 7,359,504 discloses a method and device for removing echo and noise components from a sound signal. Specifically, the device disclosed in U.S. Pat. No. 7,359,504 separates a sound signal into a voice component and a noise component, and applies beamforming processing thereon to remove echo from each component. Then, the device disclosed in U.S. Pat. No. 7,359,504 generates an output signal for removing the noise component based on the voice component and the noise component from which echo has been removed.

### SUMMARY

The device disclosed in U.S. Pat. No. 7,359,504 can acquire voice of a speaker, which is the target of sound collection, with a high signal-to-noise ratio by removing echo and noise components. However, when the speaker is in an open space and a person who is far away and is not the target of sound collection speaks, there is the risk that the person's voice is collected rather than being removed as noise.

An object of one embodiment of this disclosure is to provide a sound collection setting method that does not collect voice from a distant location or nearby noise.

A sound collection setting method for setting directionality of a microphone according to one embodiment of this disclosure comprises setting a threshold separation angle, and orienting the directionality of the microphone toward a range of a sound source position where a separation angle between a normal direction of a surface on which the microphone is installed and a direction from a position at which the microphone is installed to a sound source is equal to or less than the threshold separation angle.

### BRIEF DESCRIPTION OF THE DRAWINGS

FIG. 1 is a block diagram showing a configuration of a sound collection device.

FIG. 2 is a diagram showing one example of an operating environment of the sound collection device.

FIG. 3 is a flowchart showing an operation of a sound collection setting method.

FIG. 4 is a block diagram showing a functional configuration of a processing unit according to a first embodiment.

FIG. 5 is a top view showing a sound collection range.

FIG. 6 is a block diagram showing a functional configuration of a processing unit according to a second embodiment.

FIG. 7 is a diagram showing an example of calculating a threshold separation angle based on position information that is input.

FIG. 8 is a block diagram showing a functional configuration of a processing unit according to a third embodiment.

FIG. 9 is a top view showing a sound collection range when directionality is oriented toward an azimuth angle of each speaker.

FIG. 10 is a diagram showing an example in which the directionality is adjusted for the azimuth angle of each speaker.

FIG. 11 is a diagram showing an example of calculating a separation angle lower limit for removing noise from above.

FIG. 12 is a diagram showing a gain function.

FIG. 13 is a diagram showing specification of a sound collection range.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### First Embodiment

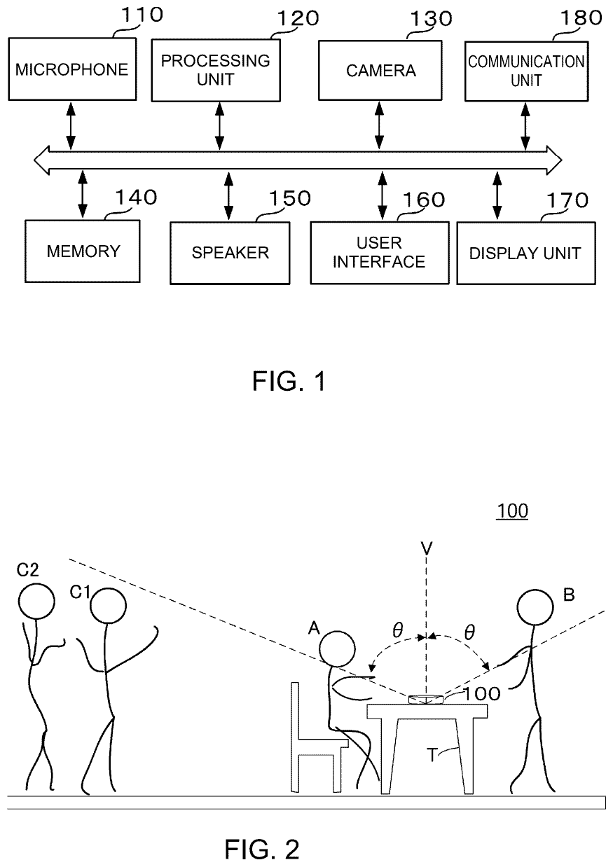

FIG. 1 is a block diagram showing a configuration of a sound collection device 100. FIG. 2 is a diagram showing one example of an operating environment of the sound collection device 100. The sound collection device 100 is an audio equipment equipped with a speaker and a microphone, for example, and is installed on a desk T. Speakers A and B participating in a conference are gathered around the desk T. The speakers A and B can converse with remote conference participants via the sound collection device 100. However, the sound collection device 100 is not limited to an audio equipment equipped with a speaker and a microphone, and can be an independent microphone and a computer connected to the independent microphone.

The sound collection device 100 comprises at least a microphone 110, a processing unit 120, a camera 130, memory 140, a speaker 150, a user interface (I/F) 160, a display unit 170, and a communication unit 180. In the present embodiment, the microphone 110 is a microphone array (not shown) that has variable directionality and that includes a plurality of microphone units. The plurality of microphone units are arranged in a circular shape on the outer side of the sound collection device 100 in plan view, for example. However, the arrangement of the plurality of microphones is not limited to a circular shape in plan view. It suffices if two or more microphone units do not overlap as viewed from each direction parallel to the surface (for example, upper surface of the desk T) on which the microphone units are arranged.

The processing unit 120 is, for example, a processor such as a central processing unit (CPU (Central Processing Unit)) that comprehensively controls the operation of the sound collection device 100 by reading an operation program from the memory 140. The processing unit 120 is one example included in an electronic controller of the sound collection device 100, and the electronic controller can be configured to comprise one or more processors. Here, the term “electronic controller” as used herein refers to hardware, and does not include a human. The memory 140 is, for example, a storage medium such as flash memory. It is not necessary for the program to be stored in the memory 140. For example, the program can be stored on a storage medium of an external device, such as a server. In this case, the processing unit 120 can read the program from the server via the communication unit 180 to thereby execute the program each time.

The camera 130 acquires an image of the surroundings centered on the sound collection device 100, for example. For example, faces of the speakers A and B are included in the acquired image. The processing unit 120 can transmit to a remote audio device, via the communication unit 180, voices and images acquired by the microphone 110 and the camera 130, allowing remote conference participants to understand the words and actions of the speakers A and B. Furthermore, the processing unit 120 can reproduce, using the speaker 150 and the display unit 170, voices and images of the remote conference participants received via the communication unit 180, thereby allowing the speakers A and B to understand the words and actions of the remote conference participants. The display unit 170 is, for example, a display such as a liquid crystal display or an LED display integrated with the sound collection device 100. However, the display unit 170 can be a display such as an independent liquid crystal display or LED display that is connected to the sound collection device 100.

The user interface 160 is a user operable input such as for example, a touch panel or a keyboard. The speakers A and B can control the sound collection device 100 via the user interface 160. As an example, the speakers A and B can adjust the volume of the reproduced voice via the user interface 160.

When conference audio equipment is used in a closed indoor environment, there are only conference participants in the room so voices of persons other than the conference participants are not collected. However, in the case of an open space, such as that shown in FIG. 2, there may be persons other than the conference participants, for example, speakers C1 and C2, who are a certain distance or more away from the conference audio equipment. And when the speakers C1 and C2 are present, the conference audio equipment can collect voices of the speakers C1 and C2.

In order to solve the problem of voices of non-participants like the speakers C1 and C2 being collected, the sound collection device 100 according to the present embodiment executes a sound collection setting method that can remove voices of non-participants who are a certain distance or more away.

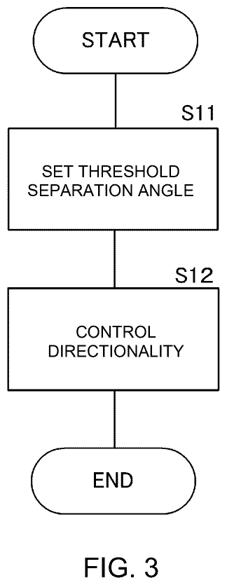

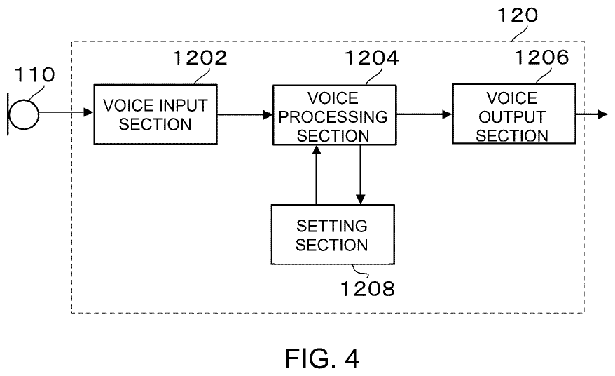

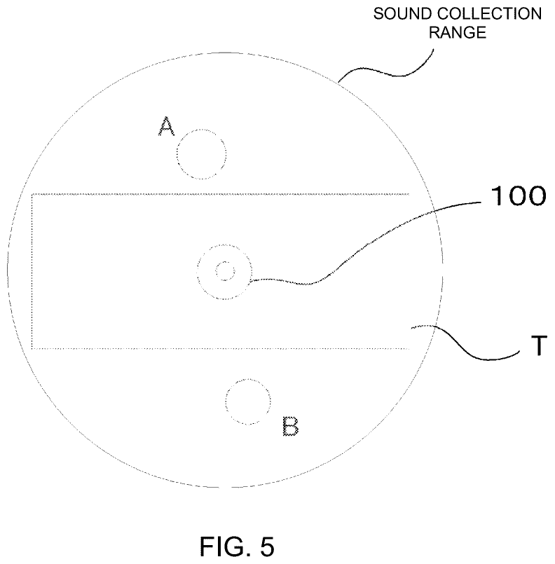

FIG. 3 is a flowchart showing an operation of the sound collection setting method. FIG. 4 is a block diagram showing a functional configuration of the processing unit 120. FIG. 5 is a top view showing a sound collection range. The processing unit 120 realizes the functional configuration shown in FIG. 4 using a program read from the memory 140, and executes the sound collection setting method shown in FIG. 3.

The processing unit 120 functionally comprises a voice input section 1202, a voice processing section 1204, a voice output section 1206, and a setting section 1208. The setting section 1208 sets a threshold separation angle θ from a vertically upward direction V (step S11). The vertically upward direction V used herein in not limited to a direction opposite to gravity, and can be a direction normal to the upper surface of the desk T. After setting the threshold separation angle θ, the voice processing section 1204 orients the directionality of the microphone 110 toward a range within the threshold separation angle θ (range of a sound source position) that has been set (step S12). As a result, the sound collection range of the microphone 110 forms an upward cone such as those shown in FIGS. 2 and 5, for example. In addition, when viewing the sound collection device 100 in plan view, the sound collection range becomes a circle as shown in FIG. 5.

In the present embodiment, in S11, the setting section 1208 sets the threshold separation angle θ from the vertically upward direction V based on the direction from which the voice of the speaker collected by the microphone 110 arrives. Specifically, before starting the conference, or at the time of starting the conference, the sound collection device 100 first collects the voice of a speaker participating in the conference, for example, the speaker A shown in FIG. 2. After the microphone 110 collects the voice of the speaker A, the voice input section 1202 inputs the collected sound signal from the microphone 110. The voice processing section 1204 analyzes the collected sound signal that has been input to estimate the direction from which the voice arrived. Examples of methods for analyzing the collected sound signal include the cross-correlation method, delay-and-sum method, multiple signal classification (MUSIC) method, and the like. The voice arrival direction estimated by the analysis method described above is represented by a spatial vector, for example. After estimating the voice arrival direction, the setting section 1208 compares the voice arrival direction and the vertically upward direction V to obtain the separation angle, and sets the same as the threshold separation angle θ. Specifically, the setting section 1208 calculates the angle formed between the obtained spatial vector and a vertically upward line, and sets the calculated angle as the threshold separation angle θ. FIG. 2 illustrates one example in which the separation angle between a normal direction (V) of the surface on which the microphone 110 is installed and a direction from a position at which the microphone 110 is installed to the sound source (the speaker A) is the same as the threshold separation angle θ. However, the threshold separation angle θ is not limited to an exact separation angle, and can be set to, from among prescribed values such as 80°, 70°, 60°, and 50°, the value closest to the true separation angle. In addition, in order to provide a margin, the threshold separation angle θ can be set to a value slightly larger than the calculated separation angle.

If there is a plurality of speakers participating in a conference as shown in FIG. 2, the voice arrival direction and distance can be estimated for all of the speakers A and B, and the separation angle from the vertically upward direction V corresponding to each of the speakers A and B can be calculated. In that case, the setting section 1208 can set the threshold separation angle θ based on the speaker with the greatest separation angle from the vertically upward direction V, such that voices of all of the speakers A and B participating in the conference are captured.

After setting the threshold separation angle θ, the voice processing section 1204 adjusts the directionality of the microphone 110 based on the threshold separation angle θ. Specifically, the voice processing section 1204 carries out beamforming to adjust the directionality of the microphone 110. Generally speaking, beamforming is a process of forming a sound collection beam having directionality toward a specific direction or range, by delaying and adding each of the collected sound signals acquired by the plurality of microphone units of the microphone 110. The voice processing section 1204 forms a sound collection beam directed toward a range defined by the threshold separation angle θ to thereby orient the directionality of the microphone 110 to a range in which the separation angle is within the threshold separation angle θ. The directionality formed by beamforming can be achieved not only by a method of forming a fixed directionality with gain in the range defined by the threshold separation angle θ, but also by a method of forming directionality with gain in the range defined by the threshold separation angle θ through a system that responds only to sound arriving from within the range defined by the threshold separation angle θ and that dynamically forms a directionality toward the direction of arrival that is narrower than the range defined by the threshold separation angle θ.

Examples of the beamforming carried out by the voice processing section 1204 include: a process of adding a delay-and-sum type sound collection beam output oriented toward each conference participant; a minimum variance processing that minimizes the overall power while applying certain constraints to the gain in the direction of each conference participant; a generalized sidelobe canceller (GSC) processing that uses the addition of the delay-and-sum type sound collection beam output directed toward the conference participants and the output of a blocking matrix (BM) that forms a null in the direction of the conference participants; a binary mask processing in which the power of the microphone device output is compared with the power of the delay-and-sum type sound collection beam outputs divided by frequency bands, the divided delay-and-sum type sound collection beam output is attenuated only when the divided delay-and-sum type sound collection beam output is smaller by a certain amount or more, and the divided delay-and-sum type sound collection beam outputs are reintegrated; and a process in which a sound source is separated from the collected sound signal by a sound source separation method such as independent component analysis (ICA), the direction of arrival of each separated sound source signal is determined by the projection back (PB) method, and only the sound source signal arriving from the direction of the conference participants is mixed.

As a result of the voice processing section 1204 orienting the directionality of the microphone 110 to a range within the threshold separation angle θ, the speakers C1 and C2 who are far from the sound collection device 100 are excluded from the sound collection range, as shown in FIG. 2. In addition, noise generated on the top surface of the desk T close to the sound collection device 100, such as the sound of taking notes, is also not collected. As a result, the sound collection device 100 does not collect, with high sensitivity, voices other than those of the speakers A and B participating in the conference. Accordingly, the collected sound signal output to the voice output section 1206 is able to obtain, with high sensitivity, only the voices of the speakers A and B participating in the conference.

As a reference example, when the conference audio equipment is installed above the speakers, such as on the ceiling, the conference audio equipment must form a sound collection beam downward from the ceiling in order to collect the voices of the speakers A and B. In that case, the conference audio equipment of the reference example acquires sound generated on the top surface of the desk T even if the directionality of the microphone is oriented to a range within the threshold separation angle from the vertically downward direction, so noise generated on the desk (such as the sound of tapping the desk and typing of a keyboard) will be collected. In contrast, the sound collection device 100 according to the present embodiment orients the directionality of the microphone to a range within a prescribed threshold separation angle from the vertically upward direction V, and thus does not collect such noise on the desk.

### Second Embodiment

In the first embodiment described above, the threshold separation angle θ from the vertically upward direction V is set based on the direction of arrival of the voices of the speakers A and B, who are the conference participants. However, the method for setting the threshold value of the separation angle θ is not limited thereto. In the second embodiment, the setting section 1208 sets the threshold separation angle based on position information input by a conference participant.

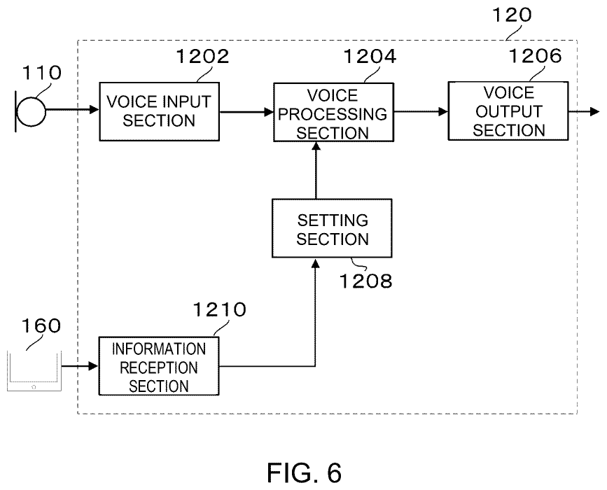

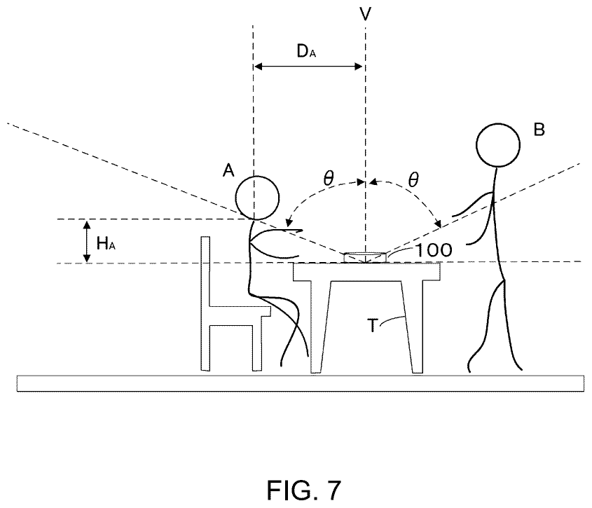

FIG. 6 is a block diagram showing a functional configuration of the processing unit 120 according to the second embodiment. The configurations that are the same as those in FIG. 4 have been assigned the same reference numerals and their descriptions have been omitted. In the present embodiment, the processing unit 120 further comprises an information reception section 1210. The information reception section 1210 receives, from the user interface 160 or the communication unit 180, position information that is input by a conference participant. The position information input by a conference participant is, for example, the horizontal distance D_{A} of the speaker A with respect to the sound collection device 100 (horizontal distance between the sound collection device 100 and the speaker A). After receiving the position information described above, the setting section 1208 calculates the threshold separation angle θ based on the position information that has been received. FIG. 7 is a diagram showing an example of calculating the threshold separation angle θ based on the input position information. Specifically, after receiving the position information from the conference participant, the setting section 1208 uses an inverse trigonometric function, for example, to calculate the threshold separation angle θ from distance D_{A} and height H_{A} of the speaker A relative to the sound collection device 100. The height H_{A} of the speaker A relative to the sound collection device 100 is a preset constant value, and the constant value is, for example, the difference between the average height of a desk and the average height of the mouth of a seated person. For example, the constant value is 0.4 meters or 0.5 meters.

The position information input by a conference participant is not limited to the horizontal distance D_{A}. For example, a conference participant can input the distance of the speaker A relative to the sound collection device 100 (spatial distance between the sound collection device 100 and the speaker A) instead of the horizontal distance D_{A}. Even if the input information changes, the setting section 1208 can use an inverse trigonometric function to calculate the threshold separation angle θ. In addition, the height H_{A} of the speaker A relative to the sound collection device 100 can be the difference between the average height of a desk and the average height of the lower jaw of a seated person.

Furthermore, a speaker participating in the conference can be standing. In that case, the setting section 1208 can use three times the constant value to calculate the threshold separation angle θ corresponding to the speaker. Specifically, for example, when information that the speaker A is standing is further received from a conference participant, the setting section 1208 calculates the threshold separation angle θ based on three times the height H_{A} (constant value) and the horizontal distance D_{A} that have been received.

In this manner, the sound collection device 100 can remove voices of non-participants who are a certain distance or more away, without carrying out a calculation for estimating the voice arrival direction and the distance to the speaker, which tends to contain errors.

### Third Embodiment

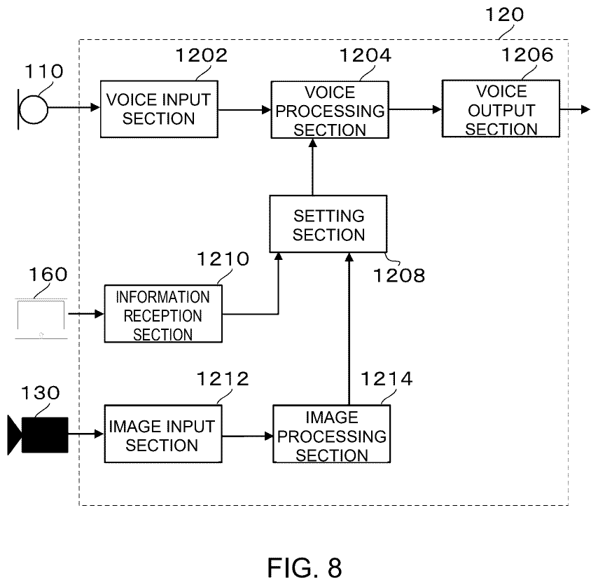

FIG. 8 is a block diagram showing a functional configuration of a processing unit according to a third embodiment. The configurations that are the same as those in FIG. 6 have been assigned the same reference numerals and their descriptions have been omitted. In the present embodiment, the processing unit 120 further comprises an image input section 1212 and an image processing section 1214. The image input section 1212 acquires from the camera 130 an image of the surroundings of the microphone 110. After acquiring an image, the image processing section 1214 carries out face detection processing, etc., to detect the speakers A and B participating in the conference from the acquired image. The face detection processing is, for example, a process of using a trained model obtained by training a prescribed model using neural networks or the like on the relationship between faces of the speakers A and B participating in the meeting and camera images, to thereby detect the speakers A and B. In order to train the model, the image processing section 1214 needs to register in advance the faces of the speakers A and B participating in the conference.

In the present embodiment, the algorithm for training the model is not limited, and any machine learning algorithm, such as a convolutional neural network (CNN) or a recurrent neural network (RNN) can be used. The machine learning algorithm can be supervised learning, unsupervised learning, semi-supervised learning, reinforcement learning, inverse reinforcement learning, active learning, transfer learning, or the like. In addition, the model can be trained by a machine learning model such as a hidden Markov model (HMM) or a support vector machine (SVM).

When the speakers A and B are detected, the image processing section 1214 further estimates the position information of the speakers A and B. Specifically, the image processing section 1214 uses a table, a function, or a model indicating the relationship between positions in an image and the azimuth angle relative to the sound collection device 100, to estimate the azimuth angles of the speakers A and B relative to the sound collection device 100 from the positions of the speakers A and B in the image.

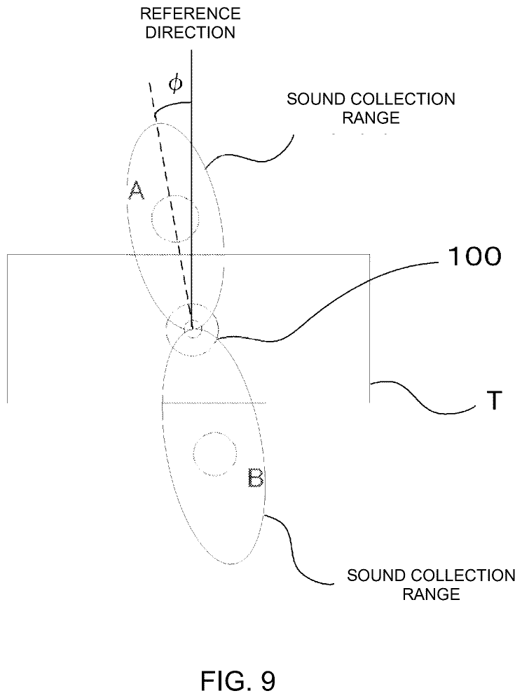

After estimating the position information of the speakers A and B, the setting section 1208 calculates the threshold separation angle θ and an azimuth angle φ toward which the sound collection beam is to be oriented in the planar direction, based on the position information received by the information reception section 1210 and the position information estimated by the image processing section 1214. As an example, when the information reception section 1210 receives the distance of the speaker A from the sound collection device 100 (the horizontal distance or the spatial distance between the sound collection device 100 and the speaker A) and the image processing section 1214 estimates the azimuth angle of the speaker A relative to the sound collection device 100, the setting section 1208 acquires a spatial vector corresponding to the speaker A and calculates the threshold separation angle θ based on the distance of the speaker A from the sound collection device 100. In addition, the setting section 1208 determines the azimuth angle φ toward which the sound collection beam is to be oriented in the planar direction based on the azimuth angle of the speaker A. For example, the setting section 1208 sets the azimuth angle of the speaker A relative to a certain reference direction (for example, due north) of the sound collection device 100 as the azimuth angle φ. Then, after the setting section 1208 determines the threshold separation angle θ and the azimuth angle φ, the voice processing section 1204 orients the directionality of the microphone 110 toward the speaker A based on the threshold separation angle θ and the azimuth angle φ. FIG. 9 is a top view showing a sound collection range when the directionality is oriented toward the azimuth angle of each speaker. As shown in FIG. 9, the voice processing section 1204 forms a sound collection beam in accordance with the azimuth angle φ, thereby adjusting the directionality of the microphone 110 in the planar direction. As a result, it is possible to orient the directionality of the microphone 110 toward the speaker A. Regarding the range of the sound collection beam in the planar direction, the setting section 1208 sets a range within approximately 40 degrees centered on the azimuth angle φ as the range of the sound collection beam in the planar direction. In this manner, the setting section 1208 can limit the range of the sound collection beam in the planar direction.

If there is a plurality of speakers participating in a conference, the azimuth angle and the threshold separation angle from the vertically upward direction V corresponding to each of the speakers A and B can be calculated based on the position information of all of the speakers A and B. In that case, the setting section 1208 can set the threshold separation angle θ based on the speaker with the greatest separation angle from the vertically upward direction V, such that voices of all of the speakers A and B participating in the conference are captured. Then, the voice processing section 1204 orients the directionality of the microphone 110 in a direction corresponding to the azimuth angle of each of the speakers A and B.

In addition, the position information of the speakers A and B estimated by the image processing section 1214 is not limited to the azimuth angles of the speakers A and B relative to the sound collection device 100. For example, the image processing section 1214 can use a table, a function, or a model indicating the relationship between distances and sizes of speakers in an image, to estimate the distances between the speakers A and B and the sound collection device 100, from the sizes of the speakers A and B in the image. Furthermore, the image processing section 1214 can use a table, a function, or a model indicating the relationship between heights of speakers in an image and heights relative to the sound collection device, to estimate the heights of the mouths of the speakers A and B relative to the sound collection device 100 from the heights of the mouths of the speakers A and B in the image. When setting the threshold separation angle θ, the distances of the speakers A and B and the heights of the mouths of the speakers A and B estimated by the image processing section 1214 can be used.

In this manner, the azimuth angle φ can be further calculated based on an image acquired by the camera 130. Accordingly, the sound collection device 100 can more accurately collect the voices of the speakers A and B based on the azimuth angle φ.

### Fourth Embodiment

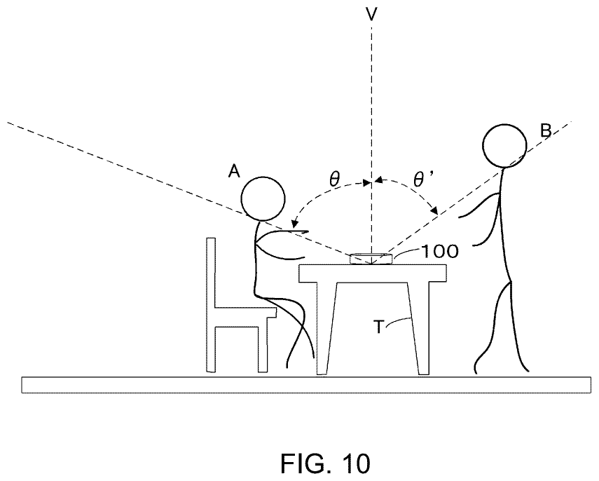

In the fourth embodiment, the threshold separation angle can be set for each of the speakers A and B participating in the conference. FIG. 10 is a diagram showing an example in which the directionality is adjusted for the azimuth angle of each speaker. Specifically, when the postures of the speakers are different, the threshold separation angle for collecting the sound of each of the speakers A and B can be different. For example, as shown in FIG. 10, a separation angle θ′ calculated based on the position information of the speaker B is smaller than the separation angle θ calculated based on the position information of the speaker A. Therefore, by limiting the directionality of the microphone 110 oriented in a direction corresponding to the azimuth angle of the speaker B to within the range of the separation angle θ′ instead of the separation angle θ, the sound collection device 100 can more accurately collect the voice of the speaker B.

### Fifth Embodiment

When holding a conference using the sound collection device 100, noise can occur above the sound collection device 100. As an example, the operating sound of an air conditioner installed on the ceiling is noise, and, if collected by the microphone 110, would cause discomfort to speakers participating in the conference.

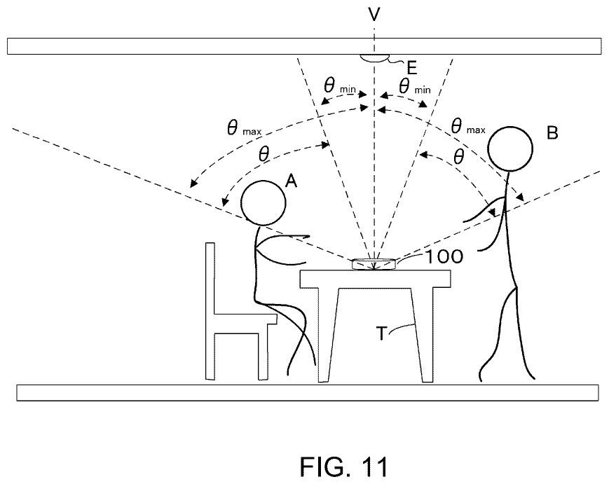

FIG. 11 is a diagram showing an example of calculating a threshold separation angle for removing noise from above. Specifically, if there is a noise source E above the sound collection device 100, the setting section 1208 sets the threshold separation angle from the vertically upward direction V corresponding to the noise source E further based on the direction of arrival of the noise, the position information of the noise source E obtained by image recognition, or information on the noise input by a speaker participating in the conference. In the present embodiment, the threshold separation angle corresponding to the noise source E is set as a separation angle lower limit θmin. In addition, the separation angle corresponding to the speakers A and B participating in the conference is set as a separation angle upper limit θmax. The voice processing section 1204 orients the directionality of the microphone 110 to a range of less than or equal to the separation angle upper limit θmax and greater than or equal to the separation angle lower limit θmin (that is, the range of the separation angle θ shown in FIG. 11). The separation angle lower limit θmin can be, instead of a separation angle corresponding to the noise source E, a separation angle lower limit calculated using three times the constant value of the second embodiment, for example.

As a result, it is possible to remove the noise above the sound collection device 100.

### Sixth Embodiment

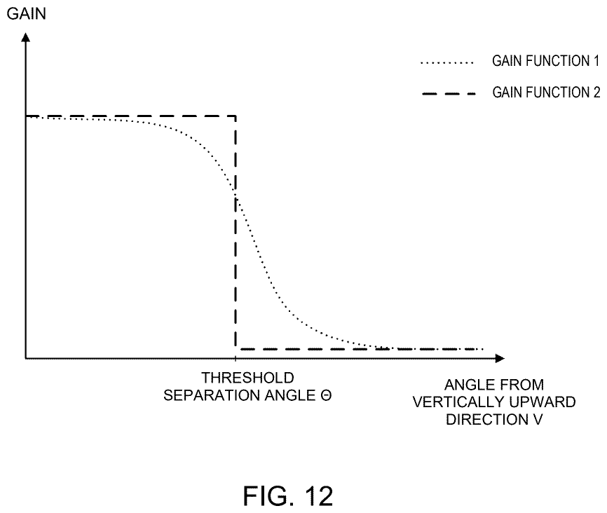

In addition to adjusting the directionality of the microphone 110 based on the set threshold separation angle θ, The voice processing section 1204 sets the gain of the microphone 110 in accordance with the threshold separation angle θ. Specifically, after carrying out beamforming, the voice processing section 1204 compensates the level of the collected sound signal after the beamforming processing using a predetermined gain function. FIG. 12 is a diagram showing a gain function. In the present embodiment, the gain function is determined in accordance with the threshold separation angle θ. Specifically, the gain function can be a function that monotonically decreases with respect to an angle from the vertically upward direction V, such as gain function 1 shown in FIG. 12, or a function in which the gain decreases in a stepwise manner at the threshold separation angle θ, such as gain function 2 shown in FIG. 12.

As a result, the sound collection device 100 can acquire, with high accuracy, the voices of the speakers A and B within the sound collection range.

### Seventh Embodiment

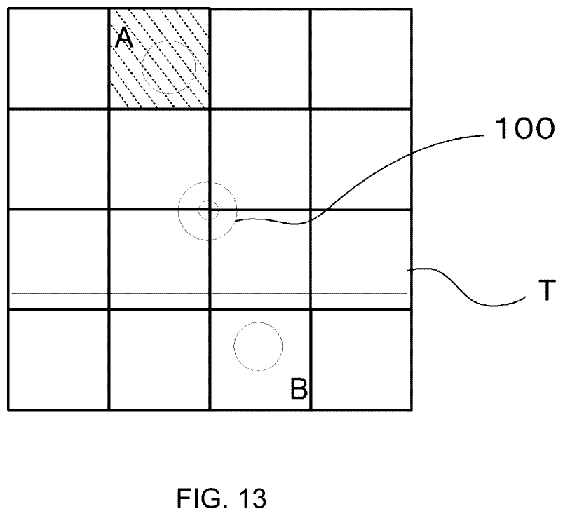

FIG. 13 is a diagram showing the specification of a sound collection range. In the present embodiment, a speaker participating in a conference can specify the sound collection range. Specifically, as shown in FIG. 13, the display unit 170 displays a plan view of the sound collection device 100 and of the operating environment of the sound collection device 100. The operating environment of the sound collection device 100 includes, for example, a desk T on which the sound collection device 100 is installed, and conference participants (that is, the speakers A and B) surrounding the desk T. In addition, the displayed screen is further divided into a grid.

A speaker participating in a conference can select grid squares via the user interface 160 to specify the sound collection range. The display unit 170 colors the selected grid squares using a color different from that of the other grid squares to indicate the specified sound collection range. As an example, when a grid square containing the speaker A is selected, only the grid square containing the speaker A is painted in a different color. In addition, the setting section 1208 sets the threshold separation angle θ based on the speaker A inside the selected grid square, and the voice processing section 1204 orients the directionality of the microphone 110 to a range within the set threshold separation angle θ and in a direction corresponding to the azimuth angle of the selected grid square. When a plurality of grid squares are selected, the setting section 1208 can set the threshold separation angle θ for each grid square.

The embodiments described above have been described separately, but the embodiments can be used in combination. For example, in the first and second embodiments, the threshold separation angle θ is set respectively based on the voice arrival direction and information input by a speaker, but the threshold separation angle θ can be set based on both the voice arrival direction and information input by the speaker. In addition, the fifth embodiment is a feature for removing noise from above and the sixth embodiment is a gain compensation feature based on the threshold separation angle θ, but said features can be used in combination with any of the first to the fourth embodiments, which are features for setting the threshold separation angle θ. Furthermore, the seventh embodiment is a feature for receiving the azimuth angle toward which the directionality of the microphone 110 is oriented, and can be used in combination with any of the second to the fourth embodiments, which are features for setting the threshold separation angle θ based on input information.

The description of the above-mentioned embodiments is exemplary in all respects and should not be considered restrictive. The scope of this disclosure is indicated by the Claims section, not the embodiment described above. Furthermore, the scope of this disclosure is intended to include a scope that is equivalent to that of the Claims section, as well as all modifications that are within the scope.

### EFFECTS OF THIS DISCLOSURE

According to one embodiment of this disclosure, it is possible to prevent collection of voice from a distant location or nearby noise.

What is claimed is:

1. A sound collection method for setting directionality of a microphone, the method comprising:
setting a threshold separation angle; and
orienting the directionality of the microphone toward a range of a sound source position in which a separation angle between a normal direction of a surface on which the microphone is installed and a direction from a position at which the microphone is installed to a sound source is equal to or less than the threshold separation angle.

2. The sound collection setting method according to claim 1, wherein
the setting of the threshold separation angle is performed by
inputting a collected sound signal from the microphone, and
estimating a direction of arrival of voice based on the collected sound signal, and
the threshold separation angle corresponds to the direction of arrival with respect to a vertically upward direction that is the normal direction of the surface.

3. The sound collection setting method according to claim 1, wherein
the setting of the threshold separation angle is performed by
acquiring an image of surroundings of the microphone,
performing face detection processing on the image,
estimating position information of a speaker upon detection of the speaker by the face detection processing, and
calculating the threshold separation angle based on the position information.

4. The sound collection setting method according to claim 3, wherein
the position information includes an azimuth angle of the speaker, and
the directionality of the microphone is further oriented toward a direction corresponding to the azimuth angle.

5. The sound collection setting method according to claim 1, wherein
the setting of the threshold separation angle is performed by
receiving a distance from the microphone, and
calculating the threshold separation angle based on the distance.

6. The sound collection setting method according to claim 1, further comprising setting gain of the microphone in accordance with the threshold separation angle after setting the threshold separation angle.

7. The sound collection setting method according to claim 1, wherein
the threshold separation angle includes a separation angle upper limit and a separation angle lower limit, and
the directionality of the microphone is oriented toward the range of the sound source position in which the separation angle is less than or equal to the separation angle upper limit and greater than or equal to the separation angle lower limit.

8. A sound collection device for setting directionality of a microphone, the device comprising:
a processor configured to
set a threshold separation angle, and
orient the directionality of the microphone toward a range of a sound source position in which a separation angle between a normal direction of a surface on which the microphone is installed and a direction from a position at which the microphone is installed to a sound source is equal to or less than the threshold separation angle.

9. The sound collection device according to claim 8, wherein
to set the threshold separation angle, the processor is configured to
input a collected sound signal from the microphone, and
estimate a direction of arrival of voice based on the collected sound signal, and
the threshold separation angle corresponds to the direction of arrival with respect to a vertically upward direction that is the normal direction of the surface.

10. The sound collection device according to claim 8, wherein
to set the threshold separation angle, the processor is configured
acquire an image of surroundings of the microphone,
perform face detection processing on the image,
estimate position information of a speaker upon detection of the speaker by the face detection processing, and
calculate the threshold separation angle based on the position information.

11. The sound collection device according to claim 10, wherein
the position information includes an azimuth angle of the speaker, and
the processor is configured to orient the directionality of the microphone toward a direction corresponding to the azimuth angle.

12. The sound collection device according to claim 8, wherein
to set the threshold separation angle, the processor is configured to
receive a distance from the microphone, and
calculate the threshold separation angle based on the distance.

13. The sound collection device according to claim 8, wherein
the processor is further configured to set gain of the microphone in accordance with the threshold separation angle after setting the threshold separation angle.

14. The sound collection device according to claim 8, wherein
the threshold separation angle includes a separation angle upper limit and a separation angle lower limit, and
the processor is configured to orient the directionality of the microphone toward the range of the sound source position in which the separation angle is less than or equal to the separation angle upper limit and greater than or equal to the separation angle lower limit.
